(19) United States
(12) Patent Application Publication
(10) Pub. No.: US 2025/0153862 A1
(43) Pub. Date: May 15, 2025

(54) DISABLED AIRCRAFT TRANSPORT SYSTEMS

(71) Applicant: Disabled Aircraft Tools, LLC, Spring Park, MN (US)

(72) Inventor: Michael Wiskus, Spring Park, MN (US)

(21) Appl. No.: 18/922,077

(22) Filed: Oct. 21, 2024

Related U.S. Application Data
(60) Provisional application No. 63/545,140, filed on Oct. 20, 2023.

(51) Int. Cl. B64F 1/225

(52) U.S. Cl. CPC B64F 1/225

(57) ABSTRACT

A dolly with a U-shaped frame has parallel side beams and a lowered bed platform of two parallel spaced plates. An open ended dolly with corresponding side beams and a platform bed may connect to the dolly with the U-shape at hinge plate connections on the side beams of the dolly with the U-shaped frame and the open ended dolly. A ramp that is lowerable to engage the tarmac is raisable to engage the platform bed of the open ended dolly. The two dollies having a combined length of at least 9 feet. An open ended dolly may have a pair of fixed ramps extending from the bed platform downwardly. Each ramped displaced inwardly in a forward rearward direction from the respective ends of the open ended dolly.

### CROSS-REFERENCE TO RELATED APPLICATIONS

The present application claims the benefit of U.S. Provisional Application No. 63/545,140 filed Oct. 20, 2023. Said application is incorporated herein by reference.

### FIELD OF THE DISCLOSURE

The present disclosure relates to systems for moving disabled aircraft. More specifically, it relates to dollies and dolly systems for attachment to and towing disabled aircraft, including systems that can support high weight disabled aircraft.

### BACKGROUND OF THE INVENTION

In aviation, certain circumstances arise wherein an aircraft must be moved without rolling on one or more of its tires. One common example is an aircraft disabled by a flat tire or a broken landing gear. If an airplane is disabled on a taxiway or, worse, on a runway, it can block that thoroughfare. This happens often enough to be, in the best case, a nuisance and, in the worst, a significant safety hazard. Often, part or all of the airport must be closed until the disabled airplane can be cleared. Often, this is an intolerable length of time, especially if the failure must be repaired on an active runway or taxiway. Furthermore, an in situ repair might be difficult or impossible. a runway making it inaccessible to other aircraft. Where the aircraft is heavy, towing with existing equipment is problematic.

In many instances, the landing gear disabled air craft may be loaded onto a dolly for moving the aircraft. In certain instances, the landing gear is not available to load on a dolly or is not sufficient support to move the disabled aircraft without damaging the aircraft. In instances the aircraft needs to be supported by its fuselage or wings for moving. See U.S. Pat. Publication 2024/0217673, owned by the owner of this application and incorporated herein by reference.

Where the disabled aircraft has tandem wheels, for example C130 transports, these are simply too big and too long for known dollies. Also, the weight of a C130 can be more than 150,000 lbs which is substantially more than conventional dollies can structurally handle. Other transport aircraft and jumbo passenger aircraft present the same or similar problems with blown tires.

There remains an unmet need for an aircraft transport system for disabled moderate to heavy weight aircraft, such as jumbo passenger jets and transport aircraft.

### SUMMARY OF THE INVENTION

Various embodiments of the present disclosure include a disabled aircraft transport system that accommodates heavy weight aircraft and landing gears with oversized tandem wheels.

Current systems for moving disabled aircraft cannot handle the weight of large transport and passenger aircraft, nor the size of the footprint cast by the wheels and tires of the landing gears of such aircraft. For expedient moving of a disabled aircraft, capturing a flat tire in a dolly allows a tow vehicle to move the aircraft with the dolly replacing the rolling capabilities of the flat tire. The heavy load of the aircraft through the landing gear is carried in such known dollies, first by the ramp and then by the bed of the dolly, the weight of the aircraft is always within the U-shaped frame of the dolly providing stability and distributing the weight throughout the multiple castors. This has been an effective solution for aircraft where the landing gear has a single wheel and tire. Large transport aircraft and passenger aircraft have landing gears with more than one wheel and tire. Where the wheels and tires of such landing gears are inoperative, known ground moving systems are not effective for quickly and readily providing a means for replacing the movability and load carrying capacities of such landing gears to easily move the aircraft on the tarmac.

The inventor has recognized the simply enlarging the size of dollies for accommodating landing gears with more than one wheel is not practical due to the excessive size and weight of such a dolly, the airport storage needs, the manufacture costs, transport costs and difficulties to get the dolly to the end user, and infrequent use, generally make such an enlarged dolly impractical.

Moreover combining known aircraft transport dollies is problematic. Such dollies have U-shaped frames for mounting castors and equipment such as winches, and a lowered bed platform a few inches off the ground. Combining, that is hitching together such dollies, does not work to effectively capture landing gears with more than one wheel. The inventor has recognized that the bed regions within the U-shaped support frames are not combinable to providing an enlarged combined bed region that can receive the footprint of the landing gear with more than one wheel. The inventor has further recognized that there are no conventional hitching means to effectively hitch together such load carrying vehicles such that loads that move, slide or roll, across the hitched together vehicles are effectively carried by the hitched together vehicles, particularly as the load moves from one vehicle to the other. The problems associated with moving excessive loads within a combined bed of hitched vehicles, particularly across juncture of the hitched vehicles, particularly in the context of disabled aircraft, has not been previously identified or recognized as a problem, or solved.

In embodiments, a high capacity dolly system has a lead forward dolly having side beams supporting multiple dual wheel castors, a recessed aircraft wheel receiving bed platform with a pair of spaced bottom plates extending between the side beams, forward crossing structure for a tow bar and winch, and further the system has, in tandem, an add-on second dolly having a pair of similar side beams supporting dual wheel castors, a recessed bed platform with a spaced pair of bottom plates supported between the two side beams, and no forward structure to provide an enlarged and elongated combined bed region. In embodiments, the forward and rear dolly are hitched at the upper side beams of both dollies, utilizing a pair of hinges with a horizontal pivot axis. In embodiments, the dollies are further hitched together with a ramp from one dolly, with the ramp in an intermediate raised position, is seated on the bed platform or the other dolly, providing a continuous bed surface extending between the two dollies. The side beams and recessed platform of the cooperating forward dolly and add-on second dolly increases the load capacity and accommodates tandem wheels of a landing gear such as on, for example, cargo aircraft, or large passenger aircraft.

A feature and advantage of embodiments is that a ramp of an existing high capacity dolly is utilized to provide the hitching together of the existing high capacity dolly to an add-on or rear dolly. In embodiments, the ramp is easily modified to provide a vertically cooperating interlocking structure between the ramp and the add-on dolly. In embodiments, the ramp has notches that interlock as the ramp is lowered onto the bed of the add-on dolly with upright structure on the add-on dolly. In embodiments, the upright structure is a unitary part of the frame of the add-on dolly. In embodiments, the upright structure comprises gussets at the side beams of the add-on dolly.

In embodiments, the lead dolly and add-on dolly are connected with the hinges on the side beams of the respective dollies with the confronting ends of the respective beams being spaced and the hinge pivot axis above the spacing and between the confronting end when viewed from above. The hinges limiting relative up-down motion of one dolly with respect to the other dolly at the connection between the dollies. This allows distribution of the load of an aircraft wheel as the wheel of the aircraft is passing over the juncture between the two dollies to both dollies. The hinge does allows some articulation about the horizontal axis at the connection to accommodate an uneven surface upon which the combined dolly sits and rolls. The articulation about the horizontal axis is limited by additional connections between the dollies. A pivotal rearward ramp of the lead dolly seats on forward projecting ramp structure and/or bed platform of the add-on dolly and the ramp is further interlocked with vertical column structures at the add-on dolly side beams. More specifically, the pivotal ramp of the lead dolly may be raised during the connection process, then lowered when the dollies are abutting one another, such that the lead ramp dolly extends over the bed platform of the add-on dolly and a pair of notches on the opposing sides of the ramp are engaged with gusset structure at the opposing side beams of the add-on dolly, interlocking the two dollies together at the bed region. This interlocking supplements the connection of the hinges at the tops of the respective beams and limits the articulation available between the two connected dollies.

When the disabled aircraft is secured to the combined dollies, the aircraft may be towed by one or more tow vehicles connecting to aircraft and/or the combined dollies.

In embodiments, a lead high capacity dolly is paired with a cooperating high capacity add-on dolly with open ends. That is, no crossing structure, forwardly or rearwardly, extending between the side beams that support the castors. The lead high capacity dolly having a steel frame with side beams and a forward crossing structure defining a U-shape, the frame supporting a multiplicity of castors, for example twelve, six under each side beam, and further supporting a recessed platform, the forward crossing structure for receiving a tow bar and winch. The cooperating add-on dolly with open ends has a pair of side beams, conforming to the side beams of the lead high capacity dolly, and further has a recessed platform formed of double spaced steel plates extending between and supported by the two side beams. The add-on dolly side beams supporting three castors under each side beam. The add-on dolly may be attached a pair of hinges attached to top surfaces of the respective beams of the lead dolly and add-on dolly. Moreover, in embodiments, a movable ramp of the lead dolly may be raised and lowered to seat on and interlock with structure on the add-on dolly. The side beams and recessed platform of the cooperating main dolly and add-on second dolly increases the load capacity and length to accommodate the high load of heavy aircraft such as the C130 as well as the length of the over-sized tandem wheels of the main landing gears of the C130.

In embodiments, dollies with open ends, may be utilized without a lead dolly with the U-shaped frame. The dolly with open ends may be inserted under the tire of a disabled aircraft and be secured therein by strapping and/or blocks or chocks on the dolly bed platform.

In embodiments, the lead high capacity dolly is usable by itself for moving most aircraft, without the add-on dolly. The lead dolly, has a reinforced articulating ramp that has a lowered position, a raised position, and intermediate positions. The ramp having a proximal planar plate portion hinged at the recessed bed platform, and a distal planar plate portion connecting to the proximal plate portion and defining the end of the ramp. In the lowered position, the end or distal plate portion has an upper surface that is parallel to the surface that the dolly is on, for example the runway. The distal end plate portion is angled with respect to the proximal plate portion hinged at the dolly bed platform. A feature and advantage of embodiments is that the end plate portion, when a disabled aircraft wheel is rolled thereon, acts as a brake with respect to the dolly, by loading the end plate portion across its width and length onto the surface below the dolly. Additionally, the ramp, when formed of ½ inch steel can weigh in excess of 100 lbs providing a secure loading onto the runway or other surface below the dolly. The lack of angled portion on the end plate portion facilitates easy entry of the aircraft wheel thereon, it only needs to clear the thickness of the end plate portion. This is particularly advantageous when the tire of the wheel is flat. The articulating ramp, in an intermediate position, may seat on the upper forward surface of a bed platform of the add-on dolly. Additionally, the ramp may interlock with structure, such as vertical gussets extending upwardly from the add-on dolly bed platform, at notches in the ramp.

A feature and advantage of embodiments is a systems that may be rapidly deployed to move disabled aircraft without requiring additional heavy machinery to be brought in and positioned such as cranes and the like. Particularly in areas such as airport runways, disabled aircraft my cause traffic delays that can be extremely disruptive to both passengers, airlines, and/or military personnel.

Embodiments of the invention can be used with a variety of aircraft and vehicle types and can be formed of various sizes and materials. Various changes and modifications will be apparent to those of ordinary skill upon reading this disclosure, all without departing from the spirit and scope of the disclosure. Accordingly, this summary, the drawings, and the detailed description are to be regarded as illustrative in nature and not restrictive.

### BRIEF DESCRIPTION OF THE DRAWINGS

FIG. 1 is a perspective view of a transport aircraft having landing gears with tandem wheels on a dolly system according to embodiments of the disclosure.

FIG. 2 is close-up perspective view of the landing gear tandem wheels of the aircraft of FIG. 1 in the dolly system.

FIG. 3 is a perspective view of an initial step of tandem wheels of an aircraft being loaded on a dolly system.

FIG. 4 is a perspective view of a subsequent step of tandem wheels of an aircraft being loaded on a dolly system following the step illustrated by FIG. 3.

FIG. 5 is a perspective view of another step of tandem wheels of an aircraft being loaded on a dolly system following the step illustrated by FIG. 4.

FIG. 6 is a rear end elevational view of the tandem wheels loaded on the combination dolly.

FIG. 7 is a perspective view of a dolly system with a lead dolly and an add-on dolly.

FIG. 8 is perspective view of the dolly system of FIG. 7 from the opposite side as that of FIG. 7

FIG. 9 is a upwardly looking perspective view of the bottom side of the dolly system of FIG. 7.

FIG. 10 is top plan view of the dolly system of FIG. 7.

FIG. 11 is front side perspective view of the dolly system of FIG. 7.

FIG. 12 is a perspective view from a rear corner of the dolly system of FIG. 7.

FIG. 13 is an upward looking perspective view of the lead dolly of FIG. 7.

FIG. 14 is a upward looking perspective view of the dolly system of FIG. 7 with the dollies separated.

FIG. 15 is a close up perspective view of connections between the lead dolly and the add-on dolly of the dolly system of FIG. 6.

FIG. 16 is a perspective view of the lead dolly with the ramp down.

FIG. 17 is an exploded view of the ramp of the lead dolly of FIG. 16.

FIG. 18 is a side elevation view of the ramp of the lead dolly of FIG. 16 as when it is lowered and engaging the surface under the dolly.

FIG. 19 is a perspective view of the ramp of FIG. 18.

FIG. 20 is a perspective view of a add-on or rear dolly of the dolly system of FIG. 7.

FIG. 21 is a upward looking perspective view of the dolly of FIG. 20.

FIG. 22 is another perspective view of the dolly of FIG. 20.

FIG. 23 is an exploded view of side beams and the bed platform of the dolly of FIG. 20.

FIG. 24 is a perspective view of a dual wheel non swivel castor.

FIG. 25 is a perspective view of a dual wheel swivel castor.

FIG. 26 is a perspective view of a hinge with a pin for connecting the lead dolly to the rear dolly.

FIG. 27 is a top plan view of a dolly in accord with embodiments.

FIG. 28 is a perspective view of the dolly of FIG. 27. The perspective view from the opposite corner being identical thereto.

FIG. 29 is a side elevation view of the dolly of FIG. 27, the view from the opposite side being identical thereto.

FIG. 30 is an end elevation view of the dolly of FIG. 27. The end elevation view from the opposite end being identical thereto.

### DETAILED DESCRIPTION

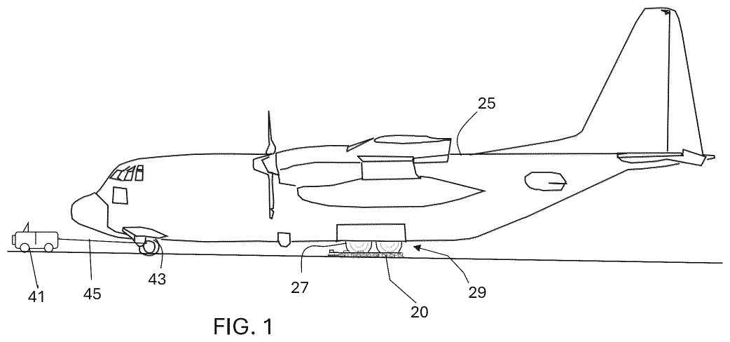

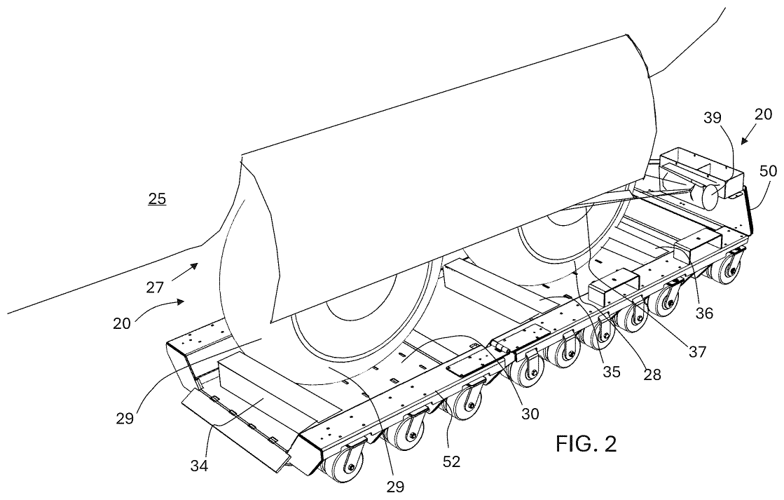

Referring to FIGS. 1 and 2, a dolly system 20 is engaged with a disabled transport aircraft 25 such as a C130. Such aircraft can weigh approximately 75,000 pounds empty and up to about 150,000 pounds fully loaded. The aircraft's tandem wheels 20 of the landing gear 27 are inoperative such as due to a flat tire. The tandem wheels 20, with a forward tire 28 and a rearward tire 29, are seated in a bed region 30 of the dolly system 20. The wheels are blocked in the bed region 30 such as by wood blocks 34, 35, 36 or wheel chocks and may be further secured with straps or cables 37 connecting to a winch 39, such that the wheels will not roll in the bed region. The dolly system effectively substitutes for the inoperative landing gear 29 allowing the tow vehicle 41 connected to the forward landing gear 43 with a tow line 45 to tow the aircraft. Another tow vehicle can simultaneously tow the dolly system.

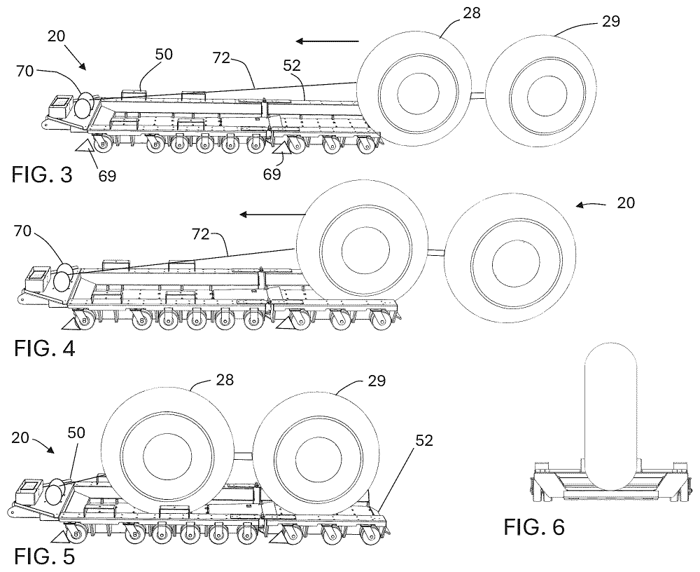

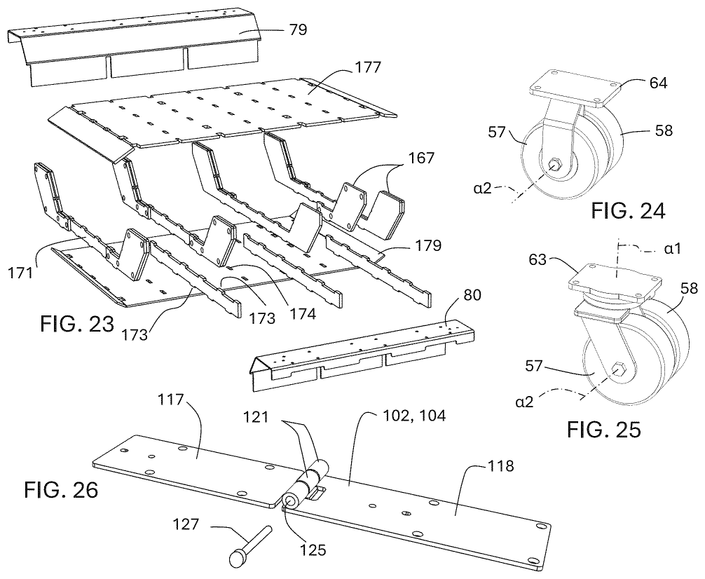

Referring to FIGS. 3-6, in embodiments, the dolly system comprises a forward high capacity dolly 50 with a U-shaped frame and a rear open ended add-on high capacity dolly 52. The lead dolly, as depicted, has six castors 56 on each side for a total of twelve castors. Referring also to FIGS. 25 and 26, each castor having two separate wheels 57, 58. Two forward castors 60,61 on each side of the lead dolly are depicted as swivel castors 63 which have a vertical axis of rotation al of the set of wheels in addition the horizontal axis of rotation α2 of the wheels. The four castors rearward of the two forward castors are depicted as non-swivel castors 64. The rearward dolly having three castors on each side.

The dolly system 20 is positioned in front of a landing gear of the disabled aircraft with the forward tire 28 abutting up against a rear ramp 67 of the rear dolly 52. The dolly system may have wheel chocks 69 placed forward of castors of each of the lead and rear dollies. The forward tire 28 may be pulled up the ramp by the winch 71 and winch line 72 attached to the landing gear, and/or by a tow vehicle pulling the aircraft forward by way of a tow line on the forward landing gear. Referring to FIGS. 4 and 5, the aircraft tires continue to move forward into the combined dolly system bed region as the dolly system moves under the tandem wheels effectuated by the pulling of the winch line 72 and the pulling of the aircraft by the tow vehicle 41. When the tandem wheels are received in the bed region of the combined dollies as illustrated in FIG. 5, the wheels may be blocked as depicted in FIG. 2. As depicted, for forward tire 28 of the tandem wheels is seated in the lead dolly 50 and the rearward tire 29 is seated in the rear dolly 52.

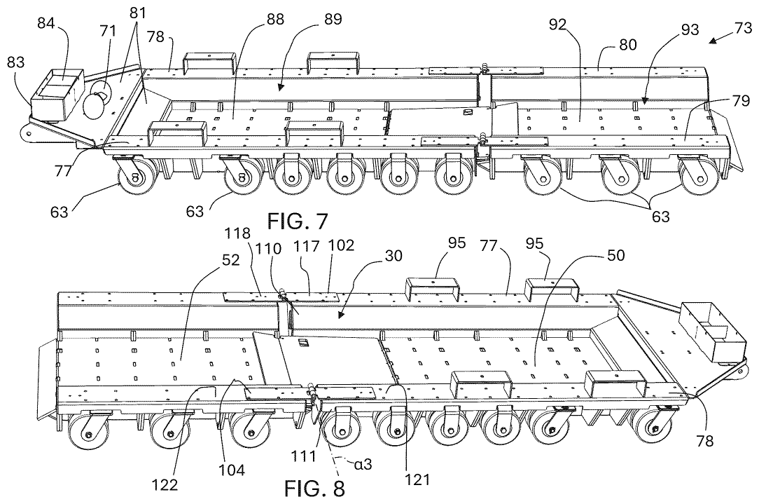

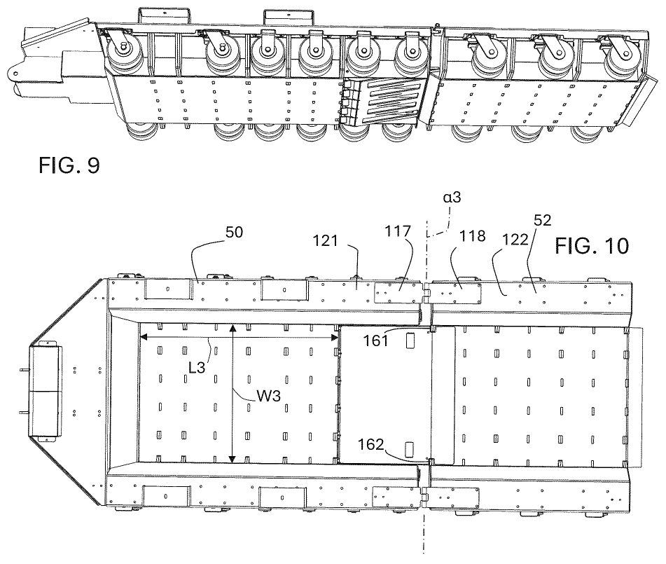

FIGS. 7-12 illustrate different views embodiments of the dolly system 20, comprising the lead dolly 50 and rear or add-on dolly 52. The combined dollies 73 have a total of nine castors on each side. Each castor with two wheels for a total of 18 wheels. The two forwardmost castors and the three rearwardmost castors are depicted as swivel castors 63. The castors are mounted on side beams 77, 78 of the lead dolly 50 and side beams 79, 80 of the rear dolly 52. The lead dolly has a forward crossing structure 81 connecting the two side beams 77, 78. The crossing structure supports 81 forward equipment such as the winch 71 and battery containment 83, and batteries 84.

The lead dolly side beams 77,78 support the lead dolly bed platform 88 and define the lead dolly bed region 89. The rear dolly side beams 79, 80 support the rear dolly bed platform 92 and define the rear dolly bed region 93. The rear dolly 52 does not have crossing structure connecting the side beams. Thus, the bed regions 89, 93 lead into each other defining a combined bed region 30 of the combined dollies 73.

Referring to FIGS. 8, 10, and 26, means for removably connecting the dollies on the side beams is illustrated. A pair of hinges 102, 104 are secured to the top of the side beams at the ends 110, 111 of the lead dolly side beams 77, 78 and at ends 113, 114 of the rear dolly side beams 79, 80. Each hinge has a pair of hinge plates 117, 118 secured to the respective top surfaces 121, 122 of the lead dolly side beams and rear dolly side beams such as by screws, bolts, welding or other known connecting means. Pin loops 121 are integral with the hinge plates 117, 118 defining a pin recess 125 and when aligned with each other, when the dollies are arranged with the forward end of the rear dolly abutted up to the rearward end of the lead dolly, the hinge pins 127 may be inserted connecting the two dollies. The pair of hinges providing a horizontal pivot axis α3 at the top of the beams or thereabove which can facilitate absorbing discontinuities in the surface upon which the dollie system is used.

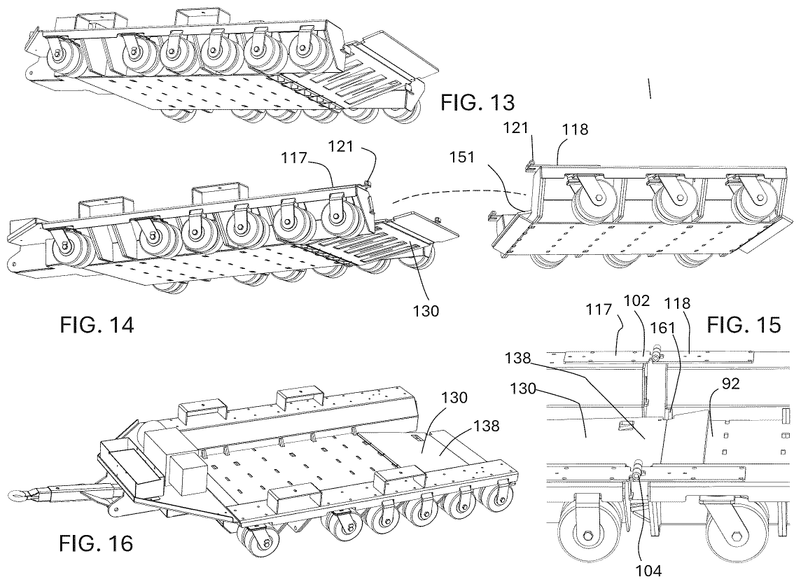

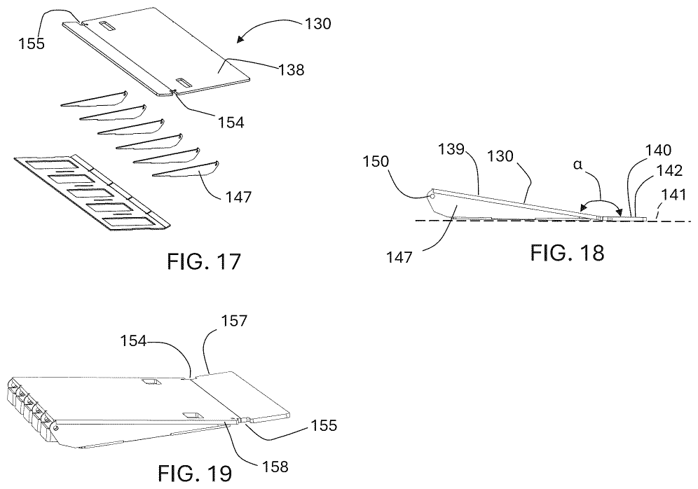

Referring to FIGS. 12-19, additional connecting means for removably connecting the lead dolly 50 to the rear dolly 52 includes a ramp 130 that is pivotally attached at a rearward margin 133 of the lead dolly bed platform 88. The ramp having and upper plate 138 two upwardly facing planar plate portions, a proximal plate portion 139, and a distal plate portion 140, that are unitary and have an angle α measured from above the plate portions of about 169° to 173°. In embodiments, angle α is from 164° to 176°. In embodiments, the distal plate portion 140 lays flat on the surface 141 that the dolly is on, with its upper surface 142 parallel to the surface that the ramp rests upon. This allows the aircraft wheel easier initial entry upon the ramp than if it was immediately confronting the angled ramp portion. The proximal plate portion may also have reinforcing structure 147 that engages or closely confronts the surface 141. The distal surface acts as a brake to the dolly when in the lowered position as shown in FIG. 16. The ramp pivots at pivot point 150 and is raisable to the raised position as shown in FIG. 13.

Referring to FIGS. 13 and 14, to connect the lead dolly and the open ended dolly the ramp needs to be raised as shown in FIG. 13 and can be latched into position. The rear dolly is positioned to closely confront the rearward end of the lead dolly and to put the loops 118 of the hinge plates 117, 118 into alignment where the hinge pin 127 may be inserted. In the raised position as shown in FIG. 133 the ramp is not engaged with the rear dolly as the hinge loops are aligned. After insertion of the hinge pins in both hinges 102, 104, the ramp may be lowered from the latched position of FIG. 13 to a lower intermediate position where the bottom surface of the ramp seats on the bed platform 92 or forward margin piece 151. The ramp has a pair of notches 154, 155 in the side edges 157, 158 of the upper plate 138 of the ramp 130. After the lead dolly and rear dolly are connected at the hinges 102, 104, the rear dolly is positioned such that the upright gusset members 161, 162 are position to be received in the notches 154, 155 when the ramp is lowered. Lowering of the ramp then creates an interlock connection 158 between the upright structure, the gussets 161, 162 of the rear dolly and the ramp of the lead dolly which can only be disconnected by the raising of the ramp. In embodiments the weight of the ramp is about 100 lbs. or more. In embodiments, the lead dolly ramp pivot axis α4 is displaced forwardly from the rear margin of the side beams, forward of the rearwardly most castor on each side, and forward of the second rearwardmost castor on each side. This results in weight loading on the ramp, when it is seated on the rear dolly, will be carried by the lead dolly at a mid portion of the ramp, forward of the rearwardmost two pairs of castors on the lead dolly, within the rectangular footprint of the first dolly castors. Even where there is direct loading of the rear ramp forward of the forwardmost set of castors This combined with the sets on the ramp, interlock connection is very secure.

The dollies may have forklift loops 95 attached to the side beams.

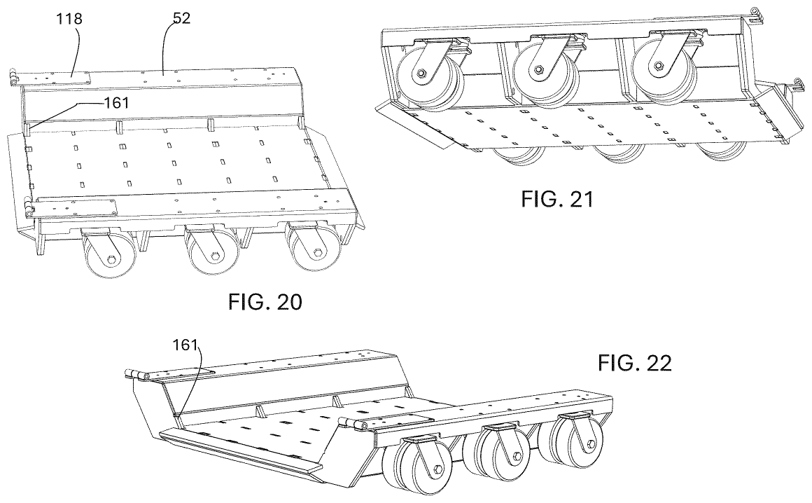

Referring to FIGS. 20-23, details of embodiments of the open ended rear add-on dolly are depicted. The rear dolly 52 has side beams 79, 80 formed, in embodiments of folded steel plate. The side beams are welded to gusset members 167 that span from side beam to side beam with stringer portions 171 that provide a spacing between the two steel plates of the platform base and have tabs 173 welded at apertures 174 in the upper platform plate 177 and lower platform plate 179. The upper platform plate 177 and lower platform plate 179 are each have a parallel planar middle portion and bends at respective forward end portions and rearward end portions.

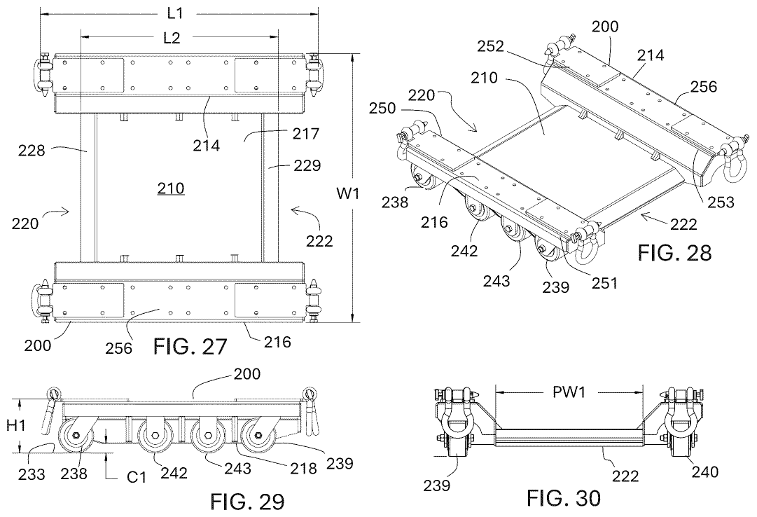

Referring to FIGS. 27-30, another open ended dolly 200 is depicted. The open ended dolly having a bed platform 210 spanning between two side beams 214, 216. The bed platform having two spaced steel plates 217, 218, as described above with reference to FIG. 23, and as described in U.S. Pat. No. 12,103,708, owned by the owner of this application and incorporated by reference herein for all purposes. As depicted, in embodiments, there are forward and rearward open areas 220, 222 with rigid fixed ramp plates 228, 229 extending from the platform toward the floor or tarmac surface 233. In this embodiment, the four end castors 238, 239, 240, three of which are illustrated, are positioned toward the forward end and rearward end and are configured as swivel castors. Four inner castors 242, 243, two of which are illustrated, are positioned laterally of the bed platform 210 are configured as non-swivel castors. Anchor locations for strapping may conveniently be positioned on the top surface of the side beams 214, 216. Plates, such as shown in FIG. 26 may be attached to each or select end portions 250, 251, 252, 253 of the top 256 of the side beams 214, 216. Clevises 260, 261, 262, 263 may be attached to the plates with pins 266. In this embodiment, without a winch, a landing gear of a disabled aircraft may be secured to the platform 210 with straps, no shown, secured to the clevises. In the embodiment of FIGS. 27-30, the overall length L1 of the dolly may be 32 to 60 inches. In embodiments, the length of the platform bed L2 may be in the range of 24 to 38 inches. In embodiments, the length of the platform bed L2 may be in the range of 30 to 36 inches. In embodiments, overall length L1 may be 42 to 48 inches. In embodiments, the overall width W1 may be 32 to 60 inches. In embodiments, the overall width W1 may be 40 to 48 inches. In embodiments, overall length H1 to the top of the plates, may be 6 to 13 inches. In embodiments, overall length H1 may be 8 to 10 inches. In embodiments, the platform width PW1 may be 18 to 36 inches. In embodiments, the platform width PW1 may be 20 to 28 inches. In embodiments, the clearance of the clearance C1 between the platform bed 210 and floor or tarmac surface 233 may be in the range of 1 to 3 inches. In embodiments, the clearance of the clearance C1 between the platform bed 210 and floor or tarmac surface 233 may be in the range of 1.5 to 2 inches.

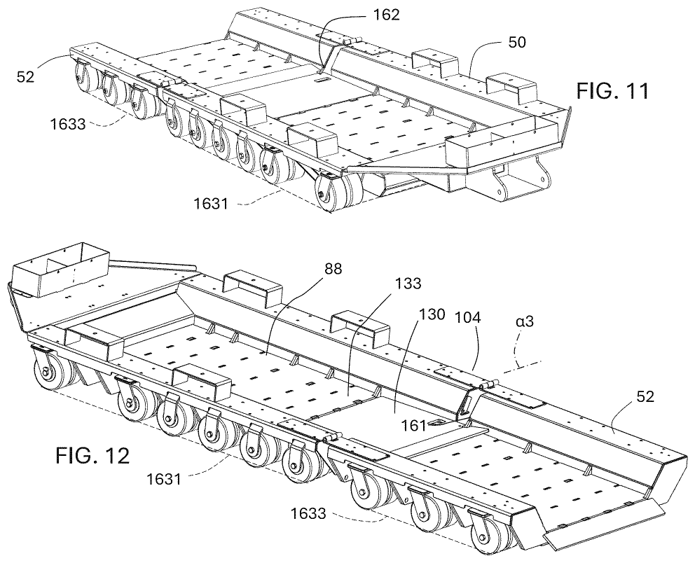

With respect to the lead dollies of FIGS. 2-16, in embodiments, the castors define, by their contact points, a rectangular dolly footprint 1631 on the surface that the lead dolly 50 rests of about 50×55 inches, or a total footprint area of about 19 square feet. In embodiments, the castors provide a lead dolly footprint 1631, by their contact points, in the range of about 17 square feet to about 22 square feet; see in particular FIGS. 11 and 12. In embodiments, the castors provide a footprint 1631, by their contact points, in the range of about 15 square feet to about 24 square feet, for example for the lead dolly 50. For the rear open ended dolly 52, the castors provide a footprint 1633 of about 12 square feet to about 20 square feet. Referring to FIG. 10, in embodiments, the width W3 of the lead U-shaped framed dolly bed platform 1599 and the open ended dolly is about 45 inches. In embodiments, the width W3 of the dolly bed platform 1599 of the lead dolly and the open ended dolly is in the range of about 40 inches to about 50 inches. In embodiments, the length L3 of the lead dolly bed platform 1599 is about 51 inches, not including the ramp 1594. In embodiments, the length L3 of the dolly bed platform 1599 is in the range of about 46 inches to about 58 inches.

Embodiments of the invention are sturdy and durable, being constructed for example of ½ inch or ⅝ inch or greater steel plate, welded solidly together. The circles on the tops of the side beams are indicative of connections such as bolt, washer, nut connections, riveted connections, or welded connections, In the case of pivoting wheels or casters, it can be desirable to ensure that all casters disposed at the corners of the dolly, at least, are pointed in the direction of the tow before towing begins, to avoid binding or undue stress on the casters. It also can be desirable for enhanced stability to leave the towbar attached to the dolly during winching or other movement of the aircraft tire onto the dolly. It will also be appreciated that during such winching or other movement, the aircraft tire may roll with respect to the dolly, the dolly may roll with respect to the tire, or both movements may occur. In any case, relative movement between the dolly and the aircraft tire occurs to move the aircraft tire into the channel and secure the tire on the platform of the dolly, for towing.

The following additional references are hereby incorporated by reference herein in their entirety, except for express definitions and patent claims contained therein: U.S. Pat. No. 1,248,896 to Olson; U.S. Pat. No. 2,362,981 to Baum; U.S. Pat. No. 2,392,409 to Ray; U.S. Pat. No. 2,608,312 to Day; U.S. Pat. No. 3,583,723 to Nowell, et al.; U.S. Pat. No. 3,586,187 to Wright; U.S. Pat. No. 3,598,259 to Wright; U.S. Pat. No. 3,720,422 to Nelson; U.S. Pat. No. 3,946,886 to Robinson et al.; U.S. Pat. No. 4,690,605 to Coccaro;

U.S. Pat. No. 4,854,803 to Coccaro; U.S. Pat. No. 5,071,151 to Irwin; U.S. Patent No.

6,286,813 to Coccaro; U.S. Pat. No. 7,070,167 to Bacon; U.S. Pat. No. 7,097,406 to Gang; U.S. Pat. No. 8,475,108 to Hamman; U.S. Patent Application Publication No. 2014/0037409 to Winters. See also “Towbar Model TY-TB-FTD”, The Brackett Aircraft Company, Inc., Kingman, AZ, USA; and “NFE-4 Aircraft Tug”, AIRTUG®, Avon, OH, USA.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

The above disclosure is related to the detailed technical contents and inventive features thereof. People skilled in this field may proceed with a variety of modifications and replacements based on the disclosures and suggestions of the invention as described without departing from the characteristics thereof. For example, although a plurality of adjustable stops as shown are useable with each of the embodiments, it is additionally or alternatively contemplated to leave the aircraft tightly secured in place with the winch and strap during towing. Although many such modifications and replacements are not fully disclosed in the above description, they have substantially been covered by the spirit and technical theory of the subject invention.

References to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112 (f) are not to be invoked unless the specific terms “means for” or “step for” are recited in the respective claim.

What is claimed is:

1. A high capacity dolly system for disabled aircraft having landing gears with tandem wheels, the dolly system comprising a lead dolly and an add-on dolly:
the lead dolly comprising:
a U-shaped frame comprising a pair of side beams and a forward crossing portion extending between forward end portions of the pair of side beams, each side beam having rearward ends;
a lower bed platform spanning between and supported by the U-shaped frame and the forward crossing portion, the lower bed platform and U-shaped frame defining a lead dolly bed region;
a ramp pivotally connected at a rearward end of the lower bed platform, the pivoting ramp having a lowered position, and upper latched position, and intermediate positions, the ramp having two planar panel portions, a proximal planar portion and a distal planar end portion joined at a juncture portion, the proximal planar portion, the distal planar end portion and the juncture portion all unitary with one another, the distal planar end portion extending rearwardly beyond the rearward ends of the side beams;
a plurality of castors positioned on each side beam, a forward castor on each of said at least five castors being a swivel castor, a rearward castor on each side beam being a non-swivel castor;
the add-on dolly comprising:
a pair of add-on side beams each aligned with the pair of lead dolly side beams when the add-on dolly is attached to the lead dolly;
a lower add-on bed platform with a forward end and a rearward end extending between the add-on side beams, the add-on platform comprising two parallel separated plates with a plurality of crossing spacers attached intermediate the two parallel separated plates, the add-on bed platform and add-on pair of side beams defining an extended bed area with an open front and open rear;
at least two castors mounted on each add-on side beam;
wherein the add-on dolly is connectable to the lead dolly at each of the respective side beams of the lead dolly and wherein the ramp of the lead dolly is raisable and lowerable onto the lower add-on bed platform of the add-on dolly there by providing a combined bed floor for receiving the tandem wheels of one of the landing gears of the disabled aircraft.

2. The high capacity dolly system of claim 1, wherein the ramp of the lead dolly interlocks with structure on the add-on dolly.

3. The high capacity dolly system of claim 2, wherein the ramp of the lead dolly has a pair of side notches that interface with structure projecting into the add-on bed region.

4. The high capacity dolly system of claim 1, wherein the lead dolly and add-on dolly are connected by connection means that precludes relative vertical motion between the rearward ends of the lead dolly pair of side beams and the forward ends of the add-on dolly's side beams.

5. The high capacity dolly system of claim 1, wherein the connection means precludes relative lateral motion between the rearward ends of the lead dolly pair of side beams and the forward ends of the add-on dolly's side beams.

6. The high capacity dolly system of claim 1, wherein the lead dolly and add-on dolly are connected with a pair of pins at cooperating interface structures on the respective lead dolly pair of side beams and on the add-on dolly pair of side beams.

7. The high capacity dolly system of claim 1, wherein the pair of beams are attached and have a common horizontal axis.

8. The high capacity dolly system of claim 1, wherein each of the pair of lead dolly beams are hingedly attached to respective ones of the add-on dolly's side beams.

9. The high capacity dolly of claim 1, wherein the combined bed floor has a length of at least nine feet and a width of at least 2.5 feet.

10. The high capacity dolly of claim 1, wherein the length of the bed floor of the add-on dolly is at least four feet.

11. The high capacity dolly of claim 1, wherein the add-on dolly has a ramp extending downwardly at a rearward margin of the bed platform.

12. A high capacity dolly system for moving aircraft weighing in excess of 50,000 pounds and having a pair of landing gears with tandem wheels, the dolly system comprising:
a pair of side beam arrangements, each side beam arrangement having a length of at least 10 feet and being spaced apart from one another by at least by about 2.4 feet;
a forward crossing portion connecting respective forward ends of the pair of side beams;
a bed platform system spanning between the pair of side beam arrangements;
each of the side beam arrangements having at least seven castors.

13. A method of moving a disabled aircraft having a pair of landing gears, each of the pair having tandem wheels, the disabled aircraft weighing at least about 75,000 lbs., the method comprising:
connecting a lead dolly comprising a raised U-shaped frame with at least five wheels on each of two sides of the U-shaped frame, and further comprising a recessed platform supported by the U-shaped frame defining a recessed bed region with a rearward bed region access opening to an add-on dolly having parallel raised elongate frame segments and a recessed platform extending between the raised elongate frame segments defining an add-on recessed bed region having a forward bed region access opening and a rearward add-on bed region access opening, wherein the connected lead dolly and add-on dolly together to provide a combined recessed bed region at least 8 feet long between raised side beams of side beams with the rearward add-on bed region access opening leading into the combined recessed bed region;
loading a forward one wheel of one of the pair of the pair of tandem wheels through the open rearward end of the two connected dollies by moving the aircraft forward with respect to the two connected dollies into the bed region;
loading the second wheel of the tandem wheels into the rearward end of the add-on dolly while moving the first wheel into the lead dolly; and
constraining the tandem wheels within the bed region of the two connected dollies;
moving the disabled aircraft with a tow vehicle.

14. The method of claim 13, further comprising fixing the relative vertical position of the add-on dolly to the horizontal position of the lead dolly during the connecting of the lead dolly to add-on dolly.

15. The method of claim 13, further comprising installing a pair of pins into a horizontally extending pair of pin access openings in a pair of hinges attached to the lead dolly and the add-on dolly.

16. The method of claim 13, wherein the lead dolly further comprises a ramp and the method comprises raising an interlocking the ramp with the add-on dolly, wherein the lead dolly further comprises a ramp and the method comprise raising and interlocking the ramp with the add-on dolly. 17-18. Cancel.

19. The method of moving a high weight aircraft of claim 13, further comprising connecting the forward dolly and rearward dolly with a plate.

20. The method of moving a high weight aircraft of claim 19, wherein the plate is a ramp pivotally attached to the forward dolly at a rearward margin of a bed platform of the forward dolly.

21. The method of claim 20, wherein the ramp overlies a bed platform of the rearward dolly and interfaces with the rearward dolly inhibiting separation of the forward dolly and rearward dolly.

22. The method of moving a high weight aircraft of claim 17, wherein the connecting in tandem comprises connecting each of two side beams of the forward dolly to each of two side beams of the rearward dolly.

23-28. (canceled)
